(19) United States
(12) Patent Application Publication
(10) Pub. No.: US 2010/0047531 A1
(43) Pub. Date: Feb. 25, 2010

(54) METHOD FOR PRINTING OR COLOURING SUBSTRATES

(75) Inventors: Pia Baum, Weinheim (DE); Heinz Heissler, Frankenthal (DE); Karl Siemensmeyer, Frankenthal (DE); Dominik Winter, Ludwigshafen (DE); Ulrike Licht, Mannheim (DE); Karl Haeberle, Speyer (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF Aktiengesellschaf, Ludwigshafen (DE)

(21) Appl. No.: 11/722,321

(22) PCT Filed: Dec. 16, 2005
(86) PCT No.: PCT/EP05/13551

§ 371 Date: Jun. 20, 2007

(30) Foreign Application Priority Data
Dec. 20, 2004 (DE) 10 2004 062 438.0

(51) Int. Cl. B32B 3/00; B05D 5/00; C09D 5/00; C09B 67/22

(52) U.S. Cl. 428/195.1; 427/256; 523/201; 427/288; 106/400

(57) ABSTRACT

The present invention relates to a process for the printing or coloring of substrates, wherein substrates to be printed or colored are brought into contact with
(A) at least one treated pigment in particulate form which is prepared by a process comprising the following steps:
   a) dispersion of at least one pigment in particulate form with at least one non-ionic surfactant,
   b) mixing of the resulting dispersion of pigment in particulate form and non-ionic surfactant with an aqueous medium,
   c) polymerization of at least one first monomer or copolymerization of a first mixture of comonomers in the presence of a mixture according to b), water-insoluble polymer or copolymer being formed on the surface of the pigment in particulate form, and
   d) addition of at least one second monomer or a second mixture of comonomers and polymerization or copolymerization,
   and also with
(B) at least one compound which is capable of crosslinking under the action of thermal energy or after the addition of a catalyst.

The present invention relates to a process for the printing or coloring of substrates, wherein substrates to be printed or colored are brought into contact with
(A) at least one treated pigment in particulate form which is prepared by a process comprising the following steps:
   a) dispersion of at least one pigment in particulate form with at least one non-ionic surfactant,
   b) mixing of the resulting dispersion of pigment in particulate form and non-ionic surfactant with an aqueous medium,
   c) polymerization of at least one first monomer or copolymerization of a first mixture of comonomers in the presence of a mixture according to b), water-insoluble polymer or copolymer being formed on the surface of the pigment in particulate form, and
   d) addition of at least one second monomer or a second mixture of comonomers and polymerization or copolymerization,
   and also with
(B) at least one compound which is capable of crosslinking under the action of thermal energy or after the addition of a catalyst.

The invention relates in particular to inks for the ink-jet process and the coloring of substrates by the ink-jet process, and to a process for the printing of two-dimensional or three-dimensional substrates, especially textile substrates, by the ink-jet process using inks according to the invention. The present invention further relates to colorant formulations, especially for formulations for coloring textile, e.g. by pigment dyeing or pigment printing. The present invention further relates to a process for the coloring of textile and to colored textile.

The present invention further relates to substrates printed with the inks according to the invention. In particular, the present invention further relates to printing pastes for pigment printing, especially textile pigment printing, and to dyeing liquors, especially for the pigment dyeing process.

Colorant formulations for use in modern substrate coloring processes, e.g. pigment dyeing, pigment printing and ink-jet processes, have to satisfy high demands. Colored substrates should have a high brightness of the colors, and the coloring should be durable, i.e. have good fastness properties, e.g. rubbing fastness.

The high demands apply particularly to colorant formulations that are used as . . . or for the production of inks for use in the inkjet process (ink-jet printing processes such as thermal ink-jet, piezo ink-jet, continuous ink-jet, valve-jet, transfer printing processes). They must have a viscosity and surface tension suitable for printing, they must be stable on storage, i.e. they should not coagulate or flocculate, and they must not cause printer nozzles to clog, which can be a problem especially with inks that comprise dispersed, i.e. undissolved, colorant particles. The demands on the storage stability of these inks additionally includes the property that the dispersed colorant particles do not settle out. Furthermore, in the case of continuous ink-jet, the inks must be stable to the addition of support electrolytes and they must not exhibit a tendency to flocculate when the ionic content increases. Moreover, the prints obtained have to satisfy the coloristic demands, i.e. exhibit high brightness and depth of shade, and must have good fastness properties, e.g. rubbing fastness, light fastness, water fastness and wet rubbing fastness, washing fastness and resistance to dry cleaning.

Inks are also required to dry rapidly on the substrate so that images or text to be printed do not run and, for example, ink droplets of different colors do not mix. The production of needle-sharp prints requires not only that the drying time of the prints be minimized, but also that the ink droplets do not run during the time they are sitting on the substrate to be printed. This capability of the ink is also referred to as holdout.

The rubbing fastness properties of colorant formulations, and especially inks for the ink-jet process, are improved in many cases by using a so-called binder, which is applied after printing or is added to the colorant formulation or ink and printed with the actual colorant formulation or ink; cf., for example, WO 99/01516, p. 14 et seq.

In some cases, however, the brightness of colorations still leaves something to be de-sired. This is the case e.g. in the application of colorant formulations containing bind-ers, when it is desired to produce trichromatic coloring systems. A migration of pigments after application is frequently observed, and needle-sharp images are thus either insufficiently durable or cannot be durably produced in the first place. Moreover, the haptic properties of printed substrates can be further improved in some cases, since it is desirable for printed substrates, and especially textile substrates, to have a pleasantly soft handle and not to be stiffened by printing.

There have been attempts to treat pigments by coating them with a polymer. U.S. Pat. No. 3,133,893 discloses the coating of pigments, which have been treated with a surfactant, with polyacrylonitrile which is synthesized in a polymerization step in the presence of the pigment. The pigments coated in this way can be incorporated into fibers. For use in the coloring of substrates, however, the haptic properties, e.g. the handle, are frequently unsatisfactory for modern requirements.

U.S. Pat. No. 4,608,401 discloses a process for the encapsulation of pigments for latex paints, where pigment particles are dispersed in water with water-insoluble monomers and a detergent under conditions devoid of shear forces, and then subjected to the conditions of an emulsion polymerization. However, for use in the coloring of substrates, the hap-tic properties, e.g. the handle, are frequently unsatisfactory for modern requirements.

U.S. Pat. No. 4,680,200 discloses a process for the encapsulation of non-pretreated pigments, where pigment particles are dispersed in water with styrene and the oligomer Polywet KX-3 from Uniroyal, and then subjected to the conditions of an emulsion polymerization.

U.S. Pat. No. 3,544,500 discloses a process for the preparation of pigments coated with special polymers, where water-soluble polymers are physically adsorbed onto the polymer and a non-solvated anchoring component is then introduced. However, the use of water-soluble polymers for coating pigments for inks for the ink-jet process is not advantageous because the coating becomes detached on prolonged storage of the ink. Moreover, printed textiles in particular have insufficient wet fastness and perspiration resistance and the washing fastness is also inadequate in many cases.

EP-A 1 245 653 discloses a process for the production of inks for the ink-jet process, where pigment particles are mixed with water-soluble monomers, e.g. acrylic acid, and other comonomers, if appropriate, and then subjected to an emulsion polymerization. The water fastness and especially the washing fastness of substrates printed with the disclosed inks are inadequate in many cases.

It is known from EP-A 1 138 512 that silica gel can be coated with a uniform polymer prepared by emulsion polymerization in the presence of the silica gel in question.

The object was to provide processes for the coloring of substrates which avoid the disadvantages known from the state of the art.

Accordingly, the process defined at the outset was found. Treated pigments (A) in particulate form are also abbreviated simply to (A) hereafter.

Substrates to be colored can consist of any desired materials and, in particular, can be flexible substrates such as leather, imitation leather or sheet polymer. Particularly preferred substrates are textile substrates. Within the framework of the present invention, textile or textile substrates are to be understood as meaning textile fibers, semifinished and finished textile products and finished goods produced therefrom, which, in addition to textiles for the clothing industry, also comprise e.g. carpets and other household textiles, as well as textile objects used for industrial purposes. These also include un-shaped objects such as flocs, linear objects such as binding threads, other threads, yarns, strings, cords, ropes and twines, and three-dimensional objects such as felts, woven fabrics, knitted fabrics, nonwovens and wadding. The textiles can be of natural origin, e.g. cotton, wool or flax, or synthetic, e.g. polyamide, polyester, modified polyester, polyester mixed woven fabrics, polyamide mixed woven fabrics, polyacrylonitrile, triacetate, acetate, polycarbonate, polypropylene, polyvinyl chloride, polyester microfibars and glass fiber woven fabrics.

The starting pigments are in particulate form. Within the framework of the present invention, pigments are to be understood as meaning practically insoluble, dispersed, finely divided organic or inorganic colorants as defined in DIN 55944.

Pigments can be selected from inorganic and, preferably, organic pigments.

Examples of selected inorganic pigments are

zinc oxide, zinc sulfide, lithopone, white lead, lead sulfate, chalk, titanium dioxide;
iron oxide yellow, cadmium yellow, nickel titanium yellow, chromium titanium yellow, chromium yellow, lead chromate, bismuth vanadate, Naples yellow or zinc yellow;
ultramarine blue, cobalt blue, manganese blue, iron blue;
ultramarine green, cobalt green, chromium oxide (chromium oxide green);
ultramarine violet, cobalt violet, manganese violet;
ultramarine red, molybdate red, chromium red, cadmium red;
iron oxide brown, chromium iron brown, zinc iron brown, manganese titanium brown;
iron oxide black, iron manganese black, spinel black, carbon black;
orange spinels and corunda, cadmium orange, chromium orange, lead molybdate; aluminum or Cu/Zn alloy.

Preferred pigments are carbon black, iron oxide pigments such as iron oxide yellow, iron oxide brown and iron oxide black, zinc oxide and titanium dioxide.

Carbon blacks which may be mentioned in particular are those produced by the gas black process, the lampblack process or the furnace black process.

The BET specific surface area of carbon black used according to the invention can range e.g. from 20 to 2000 m²/g, as determined according to DIN 66131/2 or ISO 4652.

Carbon black used according to the invention can be surface-modified, e.g. by oxidation. It can have acidic and/or basic groups, e.g. carboxyl groups, lactone groups, phenol groups, quinone groups or basic oxides having e.g. pyrone-like structures.

Examples of selected organic pigments, which also include vat dyes, are monoazo pigments such as C.I. Pigment Brown 25; C.I. Pigment Orange 5, 13, 36 and 67; C.I. Pigment Red 1, 2, 3, 5, 8, 9, 12, 17, 22, 23, 31, 48:1, 48:2, 48:3, 48:4, 49, 49:1, 52:1, 52:2, 53, 53:1, 53:3, 57:1, 63, 112, 146, 170, 184, 210, 245 and 251; C. Pigment Yellow 1, 3, 73, 74, 65, 97, 151 and 183;

bisazo pigments such as C.I. Pigment Orange 16, 34 and 44; C.I. Pigment Red 144, 166, 214 and 242; C.I. Pigment Yellow 12, 13, 14, 16, 17, 81, 83, 106, 113, 126, 127, 155, 174, 176 and 188;
anthanthrone pigments such as C.I. Pigment Red 168 and C.I. Vat Orange 3;

anthraquinone pigments such as C.I. Pigment Yellow 147 and 177; C.I. Pigment Violet 31;

anthrapyrimidine pigments such as C.I. Pigment Yellow 108; C.I. Vat Yellow 20; quinacridone pigments such as C.I. Pigment Red 122, 202 and 206; C.I. Pigment Violet 19;
quinophthalone pigments such as C.I. Pigment Yellow 138;
dioxazine pigments such as C.I. Pigment Violet 23 and 37;
diketopyrrolopyrrole pigments: C.I. Pigment Orange 71, 73 and 81; C.I. Pigment Red 254, 255, 264, 270 and 272;
flavanthrone pigments such as C.I. Pigment Yellow 24; C.I. Vat Yellow 1;
indanthrone pigments such as C.I. Pigment Blue 60 and 64; C.I. Vat Blue 4 and 6;
isoindoline pigments such as C.I. Pigment Orange 69; C.I. Pigment Red 260; C.I. Pigment Yellow 139 and 185;
isoindolinone pigments such as C.I. Pigment Orange 61; C.I. Pigment Red 257 and 260; C.I. Pigment Yellow 109, 110, 173 and 185;
isoviolanthrone pigments such as C.I. Pigment Violet 31 and C.I. Vat Violet 1;
metal complex pigments such as C.I. Pigment Yellow 117, 150 and 153; C.I. Pigment Green 8;
perinone pigments such as C.I. Pigment Orange 43; C.I. Vat Orange 7; C.I. Pigment Red 194; C.I. Vat Red 15;
perylene pigments such as C.I. Pigment Black 31 and 32; C.I. Pigment Red 123, 149, 178, 179; C.I. Vat Red 23, 190, 29 and 224; C.I. Pigment Violet 29;
phthalocyanine pigments such as C.I. Pigment Blue 15, 15:1, 15:2, 15:3, 15:4, 15:6 and 16; C.I. Pigment Green 7 and 36;
pyranthrone pigments such as C.I. Pigment Orange 51; C.I. Pigment Red 216 and C.I. Vat Orange 4;
thioindigo pigments such as C.I. Pigment Red 88 and 181; C.I. Vat Red 1; C.I. Pigment Violet 38 and C.I. Vat Violet 3;
triarylcarbonium pigments such as C.I. Pigment Blue 1, 61 and 62; C.I. Pigment Green 1; C.I. Pigment Red 81, 81:1 and 169; C.I. Pigment Violet 1, 2, 3 and 27; C.I. Pigment Black 1 (aniline black);
C.I. Pigment Yellow 101 (aldazine yellow);

### C.I. Pigment Brown 22.

Examples of particularly preferred organic pigments are C.I. Pigment Yellow 138, C.I. Pigment Red 122, C.I. Pigment Violet 19, C.I. Pigment Blue 15:3 and 15:4, C.I. Pigment Black 7, C.I. Pigment Orange 5, 38 and 43 and C.I. Pigment Green 7.

It is also possible according to the invention to start from mixtures of two or more different pigments.

The starting pigments are in particulate form, i.e. in the form of particles. It is possible, for example, to start from so-called raw pigments, i.e. untreated pigments as obtained after pigment synthesis. The particles can have a regular or irregular shape, e.g. spheres or approximate spheres or needles. For this purpose, step a) can be carried out in such a way that wet comminution takes place.

In one embodiment of the present invention, the starting pigment is preground.

In one embodiment of the present invention, the starting pigment is preground and has been coated with at least one pigment derivative, e.g. a pigment sulfonic acid, a pigment amidosulfonic acid or a methylenamine derivative of a pigment.

In one embodiment of the present invention, the particles have a spherical or approximately spherical shape, i.e. the ratio of the longest diameter to the shortest diameter ranges from 1.0 to 2.0, preferably up to 1.5.

The pigment(s) in particulate form is (are) dispersed in step a) with at least one non-ionic surfactant.

Examples of suitable non-ionic surfactants are ethoxylated mono-, di- and trialkylphenols (degree of ethoxylation: 3 to 50; alkyl radical: C₃-C₁₂) and ethoxylated fatty alcohols (number of EO: 3 to 80; alkyl radical: C₈-C₃₆), examples being the Lutensol® marks from BASF AG or the Triton® marks from Union Carbide. Particularly preferred non-ionic surfactants are ethoxylated linear fatty alcohols of general formula III:

n-CₓH₂ₓ₊₁—O(CH₂CH₂O)_{y}—H, III

in which x is an integer ranging from 10 to 24, preferably from 12 to 20. The variable y is an integer ranging preferably from 5 to 50 and particularly preferably from 8 to 40.

Ethoxylated linear fatty alcohols of general formula III are conventionally in the form of a mixture of different ethoxylated fatty alcohols with different degrees of ethoxylation. Within the framework of the present invention, the variable y is the (number-average) mean.

The dispersion of the pigment in particulate form and at least one non-ionic surfactant takes place in apparatuses suitable for this purpose, preferably in mills such as ball mills or stirred ball mills. The Drais Superflow DCP SF 12 ball mill is particularly suitable.

Dispersion times of e.g. ½ hour to 48 hours have proved suitable, although a longer time is also conceivable. A dispersion time of 5 to 24 hours is preferred.

The pressure and temperature conditions during dispersion are generally not critical. For example, normal pressure and temperatures ranging from 10° C. to 100° C. have proved suitable.

The proportions of pigment to non-ionic surfactant can be chosen within wide limits and range e.g. from 10:1 to 2:1.

Water can be added while step a) is being carried out. It is also possible to add conventional non-ionic grinding aids.

The (number-average) mean diameter of the pigments after step a) conventionally ranges from 10 nm to 5 μm, preferably from 50 nm to 3 μm.

If the pigment is carbon black, the (number-average) mean diameter of the primary particles can range e.g. from 5 to 200 nm.

Common methods, e.g. electron microscopy, are suitable for determining the mean diameter.

In step b) the dispersion of pigment in particulate form and non-ionic surfactant obtain-able in step a) is mixed with an aqueous medium. The mixing can be effected using any desired devices, e.g. stirred tanks or stirred flasks.

In terms of the present invention, aqueous media are understood as meaning liquid media which comprise water as a major component, e.g. at least 40% by weight, preferably at least 55% by weight, of water.

In step b) the weight ratio of dispersion of pigment in particulate form and non-ionic surfactant to aqueous medium generally ranges from 1:1.5 to 1:15, preferably from 1:2.5 to 1:9.

The pressure and temperature conditions for step b) are generally not critical. For ex-ample, temperatures ranging from 5 to 100° C., preferably from 20 to 85° C., and pressures ranging from normal pressure to 10 bar are suitable.

The mixing of step b) gives a mixture according to b).

In step c) at least one first monomer is polymerized or a first mixture of comonomer is copolymerized in the presence of a mixture according to b), water-insoluble polymer or copolymer being formed on the surface of the pigment in particulate form.

Step c) is carried out by adding at least one monomer or at least one mixture of co-monomers to a mixture according to b). The addition can be carried out e.g. in one portion, in several portions or continuously. If it is desired to copolymerize at least different monomers with one another, it is possible to add one comonomer first and then the second and, if appropriate, other comonomers. In another embodiment, all the co-monomers are added in one portion.

The monomers or comonomers can be added as such or in aqueous dispersion.

The chosen monomers or comonomers in step c) are those which are poorly soluble in water. Monomers or comonomers which are poorly soluble in water are understood here as meaning those whose solubility in water at 50° C. is 1×10⁻¹ mol/l or less.

Preferred examples of monomers or comonomers in step c) are vinylaromatic compounds and poorly water-soluble α,β-unsaturated carboxylic acid derivatives.

Preferably, the chosen vinylaromatic compounds are at least one compound of general formula IV:

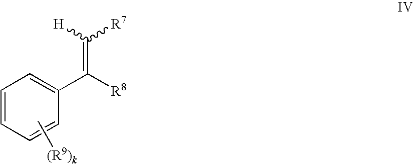

in which R⁷ and R⁸ independently of one another are each hydrogen, methyl or ethyl, R⁹ is methyl or ethyl and k is an integer from 0 to 2; very particularly preferably, R⁷ and R⁸ are each hydrogen and k=0.

Preferably, the chosen poorly water-soluble β,β-unsaturated carboxylic acid derivative is a compound of general formula I:

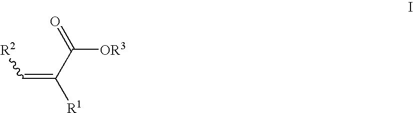

in which the variables are defined as follows:
R¹ is selected from unbranched or branched C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl and n-decyl, and particularly preferably C₁-C₄-alkyl such as methyl, ethyl, n-propyl, isopropyl, n-butyl, isobutyl, sec-butyl and tert-butyl;
   or hydrogen,
   hydrogen and methyl being very particularly preferred;
R² is selected from
   unbranched or branched C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl and n-decyl, and particularly preferably C₁-C₄-alkyl such as methyl, ethyl, n-propyl, isopropyl, n-butyl, isobutyl, sec-butyl and tert-butyl;
   or very particularly preferably hydrogen; and
R³ is selected from unbranched or branched C₄-C₁₀-alkyl such as n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl and n-decyl, n-butyl and 2-ethylhexyl being very particularly preferred.

In one embodiment of the present invention, the ratio of pigment to amount of mono-mer or comonomers in step c) ranges from 3:1 to 1:2, preferably from 2:1 to 1:1.5.

Mixtures of the aforesaid monomers can be used in step c). For example, mixtures of styrene and n-butyl acrylate, in any desired proportions, are very suitable.

The polymerization is preferably carried out under the conditions of an emulsion polymerization and very particularly preferably under so-called “starved conditions”, i.e. with the addition of only a little wetting agent or, preferably, none at all. In this way, stabilized droplets of the first monomer or the first mixture of comonomers are not obtained in measurable proportions, and the proportion of wetting agent serves to wet the pigment surface and transport the first monomer or the first mixture of comonomers through the continuous aqueous phase. Examples of suitable wetting agents are organic sulfur compounds, e.g. alkylsulfates, alkylsulfonates, alkylarylsulfonates, alkylethersulfates, alkylarylethersulfates, and sulfosuccinates such as sulfosuccinic acid half-esters and sulfosuccinic acid diesters; organic phosphorus compounds, e.g. alkyletherphosphates, are also suitable.

The polymerization is conventionally carried out using at least one initiator. At least one initiator can be a peroxide, examples of suitable peroxides being alkali metal peroxodisulfates, e.g. sodium peroxodisulfate, ammonium peroxodisulfate, hydrogen peroxide, organic peroxides such as diacetyl peroxide, ditert-butyl peroxide, diamyl peroxide, dioctanoyl peroxide, didecanoyl peroxide, dilauroyl peroxide, dibenzoyl peroxide, bis(o-tolyl) peroxide, succinyl peroxide, tert-butyl peracetate, tert-butyl permaleate, tert-butyl perisobutyrate, tert-butyl perpivalate, tert-butyl peroctoate, tert-butyl perneodecanoate, tert-butyl perbenzoate, tert-butyl peroxide, tert-butyl hydroperoxide, cumene hydroperoxide, tert-butyl peroxy-2-ethylhexanoate and diisopropyl peroxydicarbamate. Azo compounds are also suitable, examples being azobisisobutyronitrile, azobis(2-amidopropane) dihydrochloride and 2,2′-azobis(2-methylbutyronitrile).

Redox initiators, e.g. from peroxides and an oxidizable sulfur compound, are also suit-able. Very particularly preferred systems are those consisting of acetone bisulfite and an organic peroxide such as tert-C₄H₉—OOH, Na₂S₂O₅ (sodium disulfite) and an organic peroxide such as tert-C₄H₉—OOH, or a combination of an alkali metal salt of HO—CH₂SO₂H and an organic peroxide such as tert-C₄H₉—OOH. Systems such as ascorbic acid/H₂O₂ are also particularly preferred.

The chosen polymerization temperature can range from 20 to 100° C., preferably from 50 to 85° C. The chosen temperature is dependent on the decomposition characteristics of the initiator used.

The pressure conditions are generally not critical. For example, pressures ranging from normal pressure to 10 bar are suitable.

A duration of e.g. 1 to 30 minutes, preferably of 2 to 15 minutes, has proved suitable for step c).

Of course, other additives conventionally used in emulsion polymerization can be incorporated into the reaction mixture, examples being glycols, polyethylene glycols, protective colloids, buffers/pH regulators, molecular weight regulators and chain transfer inhibitors.

Isolated particles of pigment coated with polymer or copolymer are obtained in step c). The amounts of agglomerates observed are unmeasurable or only extremely small, e.g. less than 2% by weight, preferably less than 0.2% by weight.

The polymer or copolymer formed in step c) on the surface of the pigment in particulate form is water-insoluble.

In another step, the dispersed pigments in particulate form, coated with polymer or co-polymer, obtainable in c) can be isolated by purification operations, e.g. filtration, decantation and washing, and redispersed for carrying out step d). Preferably, however, the dispersed pigments in particulate form, coated with polymer or copolymer, obtain-able in c) are processed further in situ.

In step d) at least one second monomer or a second mixture of comonomers is added to the dispersion of step c) or to the worked-up and redispersed, coated pigments in particulate form, and the mixture is polymerized or copolymerized.

In the context of the present invention, reference is also made to a second mixture of comonomers in step d) if a monomer has been used in step c) and a mixture of two comonomers is added in step d). Likewise, in the context of the present invention, reference is also made to a second monomer in step d) if a mixture of comonomers has been used in step c) and a monomer is added in step d).

If it is desired to add a second mixture of comonomers, at least one comonomer is added which is different from the monomer or comonomers of step c).

In one embodiment of the present invention, a vinylaromatic compound is used as a monomer in step c) and at least one monomer or comonomer capable of swelling the polymer or copolymer of step c) is used in step d). Swelling is understood as meaning that, under normal conditions, at least 5% by weight of monomer or comonomer can be physically included in the polymer or copolymer of step c).

It is very particularly preferable to add at least one monomer or comonomer of general formula II:

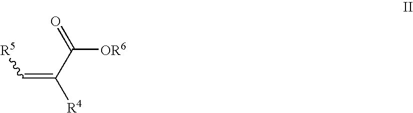

in which the variables are defined as follows:
R⁴ is selected from
   unbranched or branched C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl and n-decyl, and particularly preferably C₁-C₄-alkyl such as methyl, ethyl, n-propyl, isopropyl, n-butyl, isobutyl, sec-butyl and tert-butyl;
   or hydrogen,
hydrogen and methyl being very particularly preferred;
R⁵ is selected from
   unbranched or branched C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl and n-decyl, and particularly preferably C₁-C₄-alkyl such as methyl, ethyl, n-propyl, isopropyl, n-butyl, isobutyl, sec-butyl and tert-butyl;
   or very particularly preferably hydrogen; and
R⁶ is selected from unbranched or branched C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl and n-decyl, and particularly preferably C₁-C₄-alkyl such as methyl, ethyl, n-propyl, isopropyl, n-butyl, isobutyl, sec-butyl and tert-butyl.

If it is desired to add a mixture of comonomers in step d), it suffices if at least one co-monomer is different from the monomer or comonomer of step c). Thus it is possible, for example, to use styrene in step c) and a mixture of methyl acrylate and styrene in step d).

In one embodiment of the present invention, the weight ratio of second monomer or second mixture of comonomers of step d) to pigment of step a) ranges from 0.1:1 to 10:1, preferably from 0.5:1 to 5:1 and particularly preferably from 2:1 to 4:1.

Overall, the amount of monomers or comonomers in steps c) and d) is chosen so that the ratio of polymer or copolymer to pigment ranges from 1:1 to 5:1, preferably from 2:1 to 4:1.

In step d) the polymerization or copolymerization is preferably carried out under the conditions of an emulsion polymerization. At least one initiator is conventionally used, it being possible for the initiator(s) to be selected from those mentioned above.

It is possible to use at least one emulsifier, which can be anionic, cationic or non-ionic.

Examples of customary non-ionic emulsifiers are ethoxylated mono-, di- and trialkylphenols (degree of ethoxylation: 3 to 50, alkyl radical: C₄-C₁₂) and ethoxylated fatty alcohols (degree of ethoxylation: 3 to 80; alkyl radical: C₈-C₃₆). Examples of these are the Lutensol® marks from BASF Aktiengesellschaft and the Triton® marks from Union Carbide.

Examples of conventional anionic emulsifiers are alkali metal and ammonium salts of alkylsulfates (alkyl radical: C₈ to C₁₂), of sulfuric acid half-esters of ethoxylated alkanols (degree of ethoxylation: 4 to 30; alkyl radical: C₁₂-C₁₈) and ethoxylated alkylphenols (degree of ethoxylation: 3 to 50; alkyl radical: C₄-C₁₂), of alkylsulfonic acids (alkyl radical: C₁₂-C₁₈) and alkylarylsulfonic acids (alkyl radical: C₉-C₁₈) and of sulfosuccinates, e.g. sulfosuccinic acid monoesters and diesters.

Suitable cationic emulsifiers are normally primary, secondary, tertiary or quaternary ammonium salts having a C₆-C₁₈-alkyl, C₆-C₁₁-aralkyl or heterocyclic radical, alkanolammonium salts, pyridinium salts, imidazolinium salts, oxazolinium salts, morpholinium salts, thiazolinium salts and salts of amine oxides, quinolinium salts, isoquinolinium salts, tropylium salts, sulfonium salts and phosphonium salts. Examples which may be mentioned are dodecylammonium acetate or the corresponding hydrochloride, the chlorides or acetates of the various 2-(N,N,N-trimethylammonium)-ethylparaffinic acid esters, N-cetylpyridinium chloride, N-laurylpyridinium sulfate, N-cetyl-N,N,N-trimethylammonium bromide, N-dodecyl-N,N,N-trimethylammonium bromide, N,N-distearyl-N,N-dimethylammonium chloride and the gemini surfactant N,N′-(lauryidimethyl)ethylenediamine dibromide. Numerous other examples can be found in H. Stache, Tensid-Taschenbuch (Surfactant Pocketbook), Carl-Hanser-Verlag, Munich, Vienna, 1981, and in McCutcheon's Emulsifiers & Detergents, MC Publishing Company, Glen Rock, 1989.

In one embodiment of the present invention, the amount of emulsifier is chosen so that the weight ratio of second monomer or second mixture of comonomers, on the one hand, to emulsifier, on the other, is greater than 1, preferably greater than 10 and particularly preferably greater than 20.

The order of addition of the reactants in step d) is not critical per se.

In one embodiment of the present invention, the initiator is added when an emulsion of milky appearance has been produced, e.g. by stirring.

The chosen polymerization temperature can range from 20 to 100° C., preferably from 50 to 85° C. The chosen temperature is dependent on the decomposition characteristics of the initiator use.

The pressure conditions are generally not critical. For example, pressures ranging from normal pressure to 10 bar are suitable.

The chosen polymerization or copolymerization time in step d) can range from 30 minutes to 12 hours, a time of 2 to 3 hours being preferred.

In one embodiment of the present invention, the comonomer added in step d) can be up to 20% by weight, preferably 2 to 10% by weight, based on monomers or comonomers of step d), of at least one compound of general formula V a to V b:

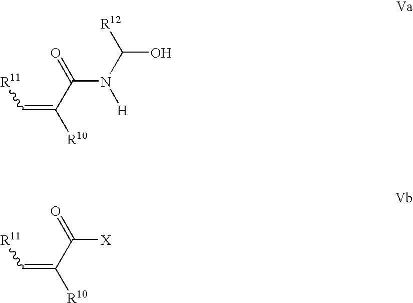

in which the variables are defined as follows:
R¹⁰ is selected from
   unbranched or branched C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl and n-decyl, and particularly preferably C₁-C₄-alkyl such as methyl, ethyl, n-propyl, isopropyl, n-butyl, isobutyl, sec-butyl and tert-butyl;
   or hydrogen,
hydrogen and methyl being very particularly preferred;
R¹¹ is selected from
   unbranched or branched C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl and n-decyl, and particularly preferably C₁-C₄-alkyl such as methyl, ethyl, n-propyl, isopropyl, n-butyl, isobutyl, sec-butyl and tert-butyl;
   or very particularly preferably hydrogen;
R¹² is selected from unbranched or branched C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl and n-decyl, and particularly preferably C₁-C₄-alkyl such as methyl, ethyl, n-propyl, isopropyl, n-butyl, isobutyl, sec-butyl and tert-butyl;
   or very particularly preferably hydrogen; and
X is selected from
   hydrogen,
   glycidyl

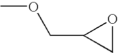

groups carrying tertiary amino groups, e.g. NH(CH₂)_{b}—N(CH₃)₂, b being an integer ranging from 2 to 6, and
enolizable groups having 1 to 20 C atoms, e.g. acetoacetyl:

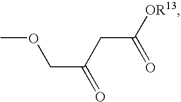

in which
R¹³ is selected from unbranched or branched C₁-C₁₀-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl and n-decyl, and particularly preferably C₁-C₄-alkyl such as methyl, ethyl, n-propyl, isopropyl, n-butyl, isobutyl, sec-butyl and tert-butyl.

Very particularly preferably, R¹⁰ in formula V a or V b is selected from hydrogen and methyl and R¹¹ and R¹² are each hydrogen.

In another embodiment of the present invention, the comonomers which can be used in step d) are in each case 1 to 20% by weight, preferably up to 5% by weight, of (meth)-acrylonitrile, (meth)acrylamide, ureido (meth)acrylate, 2-hydroxyethyl (meth)acrylate, 2-(N,N-dimethylamino)ethyl (meth)acrylate, 3-hydroxypropyl (meth)acrylate, 3-(N,N-dimethylamino)propyl (meth)acrylate, acrylamidopropanesulfonic acid, branched or unbranched, and an alkali metal salt, especially the sodium salt, of vinylsulfonic acid.

In one embodiment of the present invention, the second mixture of comonomers is chosen so as to contain in the range from 0.1 to 3% by weight, based on the amount of pigment in particulate form, of one or more unsaturated carboxylic acids of formula VI:

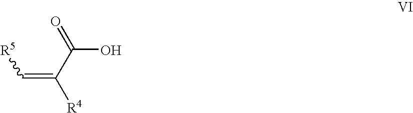

the variables in formula VI being as defined above.

In one embodiment of the present invention, the second monomer or the second mixture of comonomers is chosen so that the polymer or copolymer prepared in step d) has a glass transition temperature T_{g} of about −25° C. or above.

Another characteristic feature of the process according to the invention is that substrates to be colored are also brought into contact with
(B) at least one compound which is capable of crosslinking under the action of thermal energy or after the addition of a catalyst.

Here, substrates to be colored can be brought into contact with (A) and (B) successively, i.e. in at least two separate steps, or, preferably, simultaneously, i.e. in one step. If it is desired to bring said substrates into contact with (A) and (B) successively, an example of a possible procedure is first to bring said substrate into contact with (A), to separate off unconsumed (A) after a certain exposure time, and then to bring the substrate treated with (A) into contact with (B). This can be followed, for example, by a thermal aftertreatment or the addition of at least one catalyst. Another possible procedure is first to bring said substrate into contact with (A), then to separate off unconsumed (A) and then to bring the substrate treated with (A) into contact with (B) and at least one catalyst. Another possible procedure is first to bring said substrate into contact with (B) and at least one catalyst, then to separate off unconsumed (B) and excess catalyst, and then to bring the substrate treated with (B) into contact with (A).

If it is desired to color said substrate with (A) and (B) in one step, it is possible, for example, to add (A) to said substrate and to add (B) and, if appropriate, catalyst after a certain exposure time. This can be followed by a heat treatment. It is also possible to add (B) to said substrate and to add (A) and, if appropriate, catalyst after a certain exposure time. This can be followed by a heat treatment.

The preferred procedure is simultaneously to add said substrate to (A) and (B) and, if appropriate, catalyst, or simultaneously to add (A) and (B) and, if appropriate, catalyst to said substrate. This can be followed by a heat treatment or the addition of at least one catalyst.

In one embodiment of the present invention, (B) is selected from
(B1) melamine derivatives, which can optionally be alkoxylated, alkoxyalkylated or converted to half-aminals,
(B2) hydrophilized isocyanurates, hydrophilized diisocyanates and polyisocyanates and capped isocyanates,
(B3) polyglycidyl ethers having 2 to 5 glycidyl groups per molecule,
(B4) carbodiimides, and
(B5) urea or urea derivatives, which can optionally be converted to half-aminals or aminals.

Examples of melamine derivatives (B1) are optionally alkoxylated or alkoxyalkylated compounds or melamines converted to half-aminals, especially those of general formula VII:

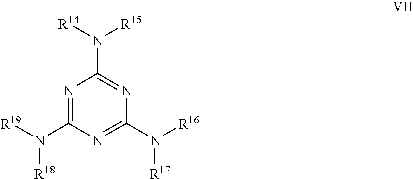

in which the variables are defined as follows:
R¹⁴R¹⁶R¹⁸ are different or, preferably, identical and selected from CH₂—OH, CH₂—O—R²⁰ and very particularly preferably hydrogen,
R¹⁵R¹⁷R¹⁹ are identical or different and selected from CH₂—OH, CH₂—O—R²⁰ and hydrogen,
at least one of the variables R¹⁴ to R¹⁹ preferably being different from hydrogen, and
R²⁰ are each identical or different and selected from C₁-C₄-alkyl, e.g. ethyl, n-propyl, n-butyl, isopropyl and especially methyl, and (CH₂CH₂O)ₘ—H, where
m is selected from integers ranging from 1 to 25.

In one particularly preferred embodiment of the present invention, the chosen melamine derivatives of general formula VII are those in which three to five of the variables R¹⁴ to R¹⁹ are hydrogen and one to three of the variables R¹⁴ to R¹⁹ are selected from CH₂—O—R², m being an integer ranging from 1 to 3.

Melamine derivatives of general formula VII are known per se. Melamine derivatives of formula VII do not generally exist in the pure state according to a definite formula; intermolecular rearrangements, i.e. transacetalization reactions and transaminalization reactions, and also to a certain extent condensation reactions and cleavage reactions, are conventionally observed. Formula VII given above is to be understood as defining the stoichiometric proportions of the variables consisting of the radicals R¹⁴ to R¹⁹ and also as including intermolecular rearrangement products and condensation products.

Examples of hydrophilized isocyanurates (B2) which may be mentioned are isocyanurates reacted with one to three equivalents of polyalkylene oxides such as poly-propylene oxide or, preferably, polyethylene oxide, e.g. those of general formula VIII:

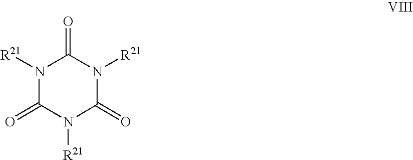

in which the variables R²¹ are different or, preferably, identical and are e.g. (CH₂)ₙ—NCO, n being an integer ranging from 2 to 20, preferably from 4 to 12; very particularly preferably, all the variables R²¹ are identical and n is 6.

The compounds cited in EP-A 0 358 979, EP-A 1 024 184, EP-A 1 110 987 and EP-A 0 728 786 may be mentioned as examples of hydrophilized diisocyanates and polyisocyanates and capped isocyanates (B2).

Pentaerythritol triglycidyl ether and glycerol 1,3-diglycidyl ether and mixtures of the aforesaid compounds may be mentioned as examples of polyglycidyl ethers (B3) having 2 to 5 glycidyl groups per molecule, preferably 2 to 4 glycidyl groups per molecule.

Dicyclohexylcarbodiimide and the systems described in patent applications EP-A 1 002 001, DE-A 199 54 500 and DE-A 100 00 656 may be mentioned as examples of carbodiimides (B4).

The following may be listed as examples of urea or urea derivatives (B5) which can optionally be converted to half-aminals or aminals: urea compounds which have optionally been alkylolated, especially methylolated, and alkoxyalkylolated, especially methoxymethylolated, several times, especially one to four times, and their di-, tri- and tetramers or oligomeric or polymeric linear, branched or cyclic precondensates. Other examples are alkylolated urea compounds as di-, tri- and tetramers or oligomeric or polymeric linear, branched or cyclic addition/condensation products of urea and poly-functional alkylaldehydes, especially glyoxal and its alkoxylated compounds, especially methoxylated compounds.

In one embodiment of the present invention, (A) and (B) are used in a weight ratio of 100:1 to 5:1, preferably of 40:1 to 10:1 and particularly preferably of 30:1 to 15:1.

Examples of suitable catalysts are ammonium chloride, ZnCl₂, Zn(NO₃)₂, and also the hydrates of each of these, NH₄Cl, and very particularly preferably MgCl₂, e.g. in the form of its hexahydrate. It is possible to use e.g. 0.001 to 1% by weight of catalyst, based on the coloring composition, e.g. dyeing liquor for textile dyeing, ink for the ink-jet process or printing paste for pigment printing.

A possible procedure for exposure to thermal energy is e.g. to bring the substrate to be printed or colored into contact with (A) and (B) and then thermally fix it at temperatures of 120° C. to 250° C. over a period of 5 seconds to 5 minutes. Examples of suitable apparatuses are microwave ovens, platen presses, drying cabinets heated by hot air fans, electricity or gas flames, heated rolls or continuous drying devices.

In one embodiment of the present invention, prior to exposure to thermal energy, the substrate can be dried, for example mechanically, e.g. by wringing, or thermally, e.g. in microwave ovens, hot air fans or drying cabinets, especially vacuum drying cabinets, it being possible to operate said drying cabinets e.g. at temperatures ranging from 30 to 110° C. In the context of vacuum drying cabinets, vacuum can be understood as meaning a pressure ranging e.g. from 0.1 to 850 mbar.

In one embodiment of the present invention, thermal drying can be effected by heating at temperatures ranging from 20° C. to 150° C., e.g. for a period of 10 seconds to 20 hours.

In one preferred embodiment of the present invention, (A) is used in a mixture with a polymer or copolymer derived from monomers or mixtures of comonomers from step d). The polymer or copolymer derived from monomers or mixtures of comonomers from step d) is preferably obtained in the form of spherical particles. The particles characterized in this way are also called pigment-free polymer particles hereafter.

In one preferred embodiment, the weight ratio of (A) to pigment-free polymer particles ranges from 10:0.1 to 10:20, preferably from 10:0.5 to 10:4.

In one preferred embodiment, the mean radii r(pigment-free polymer particles) are smaller than the mean radii r(A), based in each case on the number average. The radius ratio

$$\frac{r ( A )}{r ( pigment \text{-} free polymer particles )}$$

can range e.g. from 1.2 to 10, preferably from 1.5 to 5.

In another embodiment of the present invention, to carry out the process according to the invention, (A) is used in a mixture with untreated pigment in particulate form or pigment in particulate form which has been dispersed with at least one surfactant, which can be e.g. of a zwitterionic, anionic, cationic or non-ionic nature, but without subsequently having performed steps b) to d). The proportions of pigment present in (A) to untreated pigment or pigment in particulate form which has been dispersed with at least one surfactant, which can be e.g. of a zwitterionic, anionic, cationic or non-ionic nature, can be e.g. 5:1 to 1:5, preferably 1:1 to 1:2.

The present invention also provides inks for the ink-jet process, comprising
(A) at least one treated pigment in particulate form which is prepared by a process comprising the following steps:
   a) dispersion of at least one pigment in particulate form with at least one non-ionic surfactant,
   b) mixing of the resulting dispersion of pigment in particulate form and non-ionic surfactant with an aqueous medium,
   c) polymerization of at least one first monomer or copolymerization of a first mixture of comonomers in the presence of a mixture according to b), water-insoluble polymer or copolymer being formed on the surface of the pigment in particulate form, and
   d) addition of at least one second monomer or a second mixture of comonomers and polymerization or copolymerization, and also
(B) at least one compound which is capable of crosslinking under the action of thermal energy or after the addition of a catalyst.

The present invention also provides a process for the production of inks for the ink-jet process using at least one treated pigment (A) in particulate form and at least one compound (B) which is capable of crosslinking under the action of thermal energy or after the addition of a catalyst. The present invention also provides inks for the ink-jet process which are produced using at least one treated pigment (A) in particulate form and at least one compound (B) which is capable of crosslinking under the action of thermal energy or after the addition of a catalyst. To produce inks according to the invention for the ink-jet process, aqueous dispersions of treated pigment (A) in particulate form can be used as such, and it is also possible to use treated pigments (A) which have been separated from the dispersions described above.

Inks according to the invention for the ink-jet process can be produced particularly easily by diluting dispersions, prepared as described above, with e.g. water, and mixing them with at least one compound (B) which crosslinks under the action of thermal energy or after the addition of a catalyst, and, if appropriate, with loading materials.

In one preferred embodiment of the present invention, an ink according to the invention for the ink-jet process comprises in the region of 1 to 50 g/100 ml, preferably 1.5 to 15 g/100 ml, of (A).

As loading materials, inks according to the invention for the ink-jet process can comprise organic solvents. Low-molecular polytetrahydrofuran is a preferred loading material and can be used on its own or, preferably, in a mixture with one or more water-soluble or water-miscible organic solvents of low volatility.

The low-molecular polytetrahydrofuran that is preferably used conventionally has an average molecular weight M_{w} of 150 to 500 g. mol, preferably of 200 to 300 g. mol and particularly preferably of about 250 g. mol (corresponding to a molecular weight distribution).

Polytetrahydrofuran can be prepared in known manner via the cationic polymerization of tetrahydrofuran to form linear polytetramethylene glycols.

If polytetrahydrofuran is used in a mixture with other organic solvents as the loading material, water-soluble or water-miscible organic solvents of low volatility (i.e. usually having a boiling point of >100° C. at normal pressure), and hence possessing a water-retaining action, are generally used for this purpose.

Suitable solvents are polyhydric alcohols and preferably unbranched and branched polyhydric alcohols having 2 to 8 carbon atoms, especially 3 to 6 carbon atoms, such as ethylene glycol, 1,2- and 1,3-propylene glycol, glycerol, erythritol, pentaerythritol, pentitols such as arabitol, adonitol and xylitol, and hexitols such as sorbitol, mannitol and dulcitol.

Other suitable solvents are polyethylene and polypropylene glycols, which are also to be understood as meaning the lower polymers (di-, tri- and tetramers), and their monoalkyl ethers (where alkyl is particularly C₁-C₆ and especially C₁-C₄). Preferred polyethylene and polypropylene glycols are those with average molecular weights of 100 to 1500 g. mol, particularly of 200 to 800 g. mol and especially of 300 to 500 g. mol. Examples which may be mentioned are di-, tri- and tetraethylene glycol, diethylene glycol monomethyl, monoethyl, monopropyl and monobutyl ether, triethylene glycol monomethyl, monoethyl, monopropyl and monobutyl ether, di-, tri- and tetra-1,2- and -1,3-propylene glycol and di-, tri- and tetra-1,2- and- 1,3-propylene glycol monomethyl, monoethyl, monopropyl and monobutyl ether.

Other suitable solvents are pyrrolidone and N-alkylpyrrolidones whose alkyl chain preferably comprises 1 to 4 carbon atoms and particularly 1 or 2 carbon atoms. Examples of suitable alkylpyrrolidones are N-methylpyrrolidone, N-ethylpyrrolidone and N-(2-hydroxyethyl)pyrrolidone.

Examples of particularly preferred solvents are 1,2- and 1,3-propylene glycol, glycerol, sorbitol, diethylene glycol, polyethylene glycol (M_{w} 300 to 500 g. mol), diethylene glycol monobutyl ether, triethylene glycol monobutyl ether, pyrrolidone, N-methylpyrrolidone and N-(2-hydroxyethyl)pyrrolidone.

Polytetrahydrofuran can also be mixed with one or more (e.g. two, three or four) of the solvents listed above.

In one embodiment of the present invention, the inks according to the invention for the ink-jet process can comprise especially 0.1 to 80% by weight, preferably 5 to 60% by weight, particularly preferably 10 to 50% by weight and very particularly preferably 10 to 30% by weight of non-aqueous solvents.

The non-aqueous solvents as loading materials, including especially said particularly preferred solvent combinations, can advantageously be supplemented with urea (usually 0.5 to 3% by weight, based on the weight of the ink for the ink-jet process), which further enhances the water-retaining action of the solvent mixture.

The inks according to the invention for the ink-jet process can comprise other auxiliaries such as those conventionally used in particular for water-based ink-jet inks and in the printing and paint industry. Examples which may be mentioned are preservatives such as 1,2-benzisothiazolin-3-one (commercially available as Proxel marks from Avecia Lim.) and its alkali metal salts, glutaric dialdehyde and/or tetramethylolacety-lenediurea, Protectols®, antioxidants, degassers/defoamers such as acetylenediols and ethoxylated acetylenediols which conventionally comprise 20 to 40 mol of ethylene oxide per mol of acetylenediol and can also simultaneously have a dispersing action, viscosity regulators, flow control agents, wetting agents (e.g. surfactants with a wetting action which are based on ethoxylated or propoxylated fatty alcohols or oxo alcohols, propylene oxide/ethylene oxide block copolymers, ethoxylates of oleic acid or alkylphenols, alkylphenolethersulfates, alkylpolyglycosides, alkylphosphonates, alkylphenyl-phosphonates, alkylphosphates, alkylphenylphosphates or, preferably, polyethersiloxane copolymers, especially alkoxylated 2-(3-hydroxypropyl)heptamethyltrisiloxanes, which usually have a block of 7 to 20, preferably 7 to 12, ethylene oxide units and a block of 2 to 20, preferably 2 to 10, propylene oxide units and can be present in the colorant formulations in amounts of 0.05 to 1% by weight), antisettling agents, gloss promoters, lubricants, adhesion promoters, skinning inhibitors, matting agents, emulsifiers, stabilizers, hydrophobing agents, light stabilizing additives, handle improvers, antistatic agents, and bases such as triethanolamine, or acids, especially carboxylic acids such as lactic acid or citric acid, for regulating the pH. If these agents are constituents of colorant formulations according to the invention, and especially inks according to the invention for the ink-jet process, their total amount is usually up to 2% by weight, especially up to 1% by weight, based on the weight of the inks according to the invention for the ink-jet process.

In one embodiment of the present invention, the inks according to the invention for the ink-jet process have a dynamic viscosity of 2 to 80 mPa·s, preferably of 3 to 20 mPa·s, measured at 20° C.

The surface tension of inks according to the invention for the ink-jet process is usually 24 to 70 mN/m, especially 25 to 60 mN/m, measured at 20° C.

The pH of inks according to the invention for the ink-jet process is generally 5 to 10, preferably 6 to 9.

Another feature of the present invention is a process for the printing of two-dimensional or three-dimensional substrates by the ink-jet process using the inks according to the invention for the ink-jet process. This is done by printing the ink-jet inks according to the invention onto the substrate and then fixing the print obtained.

In the ink-jet process, the conventionally water-based inks are sprayed in small drop-lets directly onto the substrate. A distinction is made between a continuous process, where the ink is pressed uniformly through a nozzle and directed onto the substrate by an electric field that depends on the pattern to be printed, and an interrupted ink-jet or drop-on-demand process, where the ink is only ejected at points where a colored dot is to be placed. In the latter process, pressure is exerted on the inking system via either a piezoelectric crystal or a heated hollow needle (bubblejet or thermo-jet process), thus expelling an ink drop. Such procedures are described in Text. Chem. Color, volume 19 (8), pages 23 to 29, 1987, and volume 21 (6), pages 27 to 32, 1989.

The inks according to the invention are particularly suitable for the bubble-jet process and for the process that employs a piezoelectric crystal.

The following are examples of suitable substrate materials:

cellulosic materials such as paper, paperboard, cardboard, wood and wood-based materials, which can also be varnished or coated in another way,
metallic materials such as sheets, plates or workpieces made of aluminum, iron, copper, silver, gold, zinc or alloys of these metals, which can be varnished or coated in another way,
silicate-based materials such as glass, porcelain and ceramic, which can be coated,
polymeric materials of any kind, such as polystyrene, polyamides, polyesters, polyethylene, polypropylene, melamine resins, polyacrylates, polyacrylonitrile, polyurethanes, polycarbonates, polyvinyl chloride, polyvinyl alcohols, polyvinyl acetates, polyvinylpyrrolidones and corresponding copolymers and block copolymers, biodegradable polymers and natural polymers such as gelatin,
leather, including both natural leather and artificial leather, as smooth, nappa or suede
leather,
foodstuffs and cosmetics,
and especially
textile substrates such as fibers, yarns, twines, netting, woven goods, nonwovens and ready-to-wear clothing made of polyester, modified polyester and polyester mixed woven fabric, cellulosic materials such as cotton, cotton mixed woven fabric, jute, flax, hemp and ramie, viscose, wool, silk, polyamide, polyamide mixed woven fabric, poly-acrylonitrile, triacetate, acetate, polycarbonate, polypropylene, polyvinyl chloride, polyester microfibers and glass fiber woven fabric, as well as mixed woven fabric containing elastan.

The actual printing operation is followed by fixing, e.g. by the action of thermal energy or by the addition of at least one catalyst. The fixing can also be effected by printing at least one catalyst with the ink and then activating the catalyst, e.g. by heating.

Overall, the inks according to the invention for the ink-jet process exhibit advantageous use properties, particularly a good initial writing behavior and a good sustained writing behavior (cogation), and a good drying behavior, especially when using the particularly preferred solvent combination, and afford printed images of high quality, i.e. high brightness and depth of shade, as well as high rubbing fastness, light fastness, water fastness and wet rubbing fastness. They are particularly suitable for printing on coated and uncoated paper and textile.

Another embodiment of the present invention consists of substrates, especially textile substrates, which have been printed by one of the above-mentioned processes according to the invention and are distinguished by particularly sharply printed images or drawings and an excellent handle.

In another embodiment of the present invention, at least two and preferably at least three different inks according to the invention for the ink-jet process can be combined into sets, different inks according to the invention comprising different treated pigments (A), each having a different color.

Another embodiment of the present invention consists of a process for the coloring of flexible substrates, and especially textile, e.g. by dyeing or printing with one or more printing pastes for pigment printing, wherein textile to be colored is brought into contact with (A) and (B), e.g. in the form of a dyeing liquor for textile dyeing or in the form of a printing paste for pigment printing. The present invention also provides colored textile substrates obtainable by a process according to the invention for the coloring of textile substrates.

The present invention also provides dyeing liquors for textile dyeing, comprising
(A) at least one treated pigment in particulate form which is prepared by a process comprising the following steps:
   a) dispersion of at least one pigment in particulate form with at least one non-ionic surfactant,
   b) mixing of the resulting dispersion of pigment in particulate form and non-ionic surfactant with an aqueous medium,
   c) polymerization of at least one first monomer or copolymerization of a first mixture of comonomers in the presence of a mixture according to b), water-insoluble polymer or copolymer being formed on the surface of the pigment in particulate form, and
   d) addition of at least one second monomer or a second mixture of comonomers and polymerization or copolymerization, and also
(B) at least one compound which is capable of crosslinking under the action of thermal energy or after the addition of a catalyst.

The present invention also provides printing pastes for pigment printing, comprising
(A) at least one treated pigment in particulate form which is prepared by a process comprising the following steps:
   a) dispersion of at least one pigment in particulate form with at least one non-ionic surfactant,
   b) mixing of the resulting dispersion of pigment in particulate form and non-ionic surfactant with an aqueous medium,
   c) polymerization of at least one first monomer or copolymerization of a first mixture of comonomers in the presence of a mixture according to b), water-insoluble polymer or copolymer being formed on the surface of the pigment in particulate form, and
   d) addition of at least one second monomer or a second mixture of comonomers and polymerization or copolymerization,
   and also
(B) at least one compound which is capable of crosslinking under the action of thermal energy or after the addition of a catalyst.

According to the invention, the dispersions described above are used to prepare a dyeing liquor for pigment dyeing or a printing paste for pigment printing, especially textile pigment printing. The present invention thus provides a process for the preparation of dyeing liquors for pigment dyeing and for the preparation of printing pastes for pigment printing, as well as the dyeing liquors and printing pastes according to the invention, these processes also being referred to hereafter as preparative processes according to the invention. Dyeing liquors according to the invention or printing pastes according to the invention for pigment printing also comprise at least one compound (B) which is capable of crosslinking under the action of thermal energy or after the addition of a catalyst. Dyeing liquors according to the invention or printing pastes according to the invention for pigment printing can also comprise one or more catalysts.

The preparative process according to the invention consists in mixing at least one (A) with (B) and, if appropriate, with auxiliaries required for the dyeing or printing process, and adjusting the colorant content by dilution with water.

The water used to carry out the preparative process according to the invention does not have to be fully demineralized. As a rule, the water used is partially demineralized or very soft. If sufficiently soft water is not available, complexing agents (water soften-ers) are normally used to reduce the water hardness. In general, compounds which mask Ca²⁺ and Mg²⁺ ions are suitable as water softeners in the pigment dyeing process. Examples of particularly suitable water softeners are nitrilotriacetic acid, ethyl-enediaminetetraacetic acid, diethylenetriaminepentaacetic acid, hydroxyethyl-ethylenediaminetriacetic acid or methylglycinediacetic acid. The amount of water added for the preparation of the dyeing liquor depends on the one hand on the depth of shade to be achieved on the textile, and on the other hand on the amount of dyeing liquor to be applied to the textile by means of suitable apparatuses, e.g. a padding machine.

Dyeing liquors according to the invention can also comprise additives. Preferred additives are organic solvents in concentrations of 0 to 10% by weight, preferably of 0.1 to 5% by weight. Examples of suitable solvents are polyethylene glycols and monoetherified alkylene glycol or monoetherified polyethylene glycols, e.g. diethylene glycol mono-n-butyl ether.

As auxiliaries, dyeing liquors according to the invention can also comprise one or more wetting agents, low-foaming wetting agents being preferred because, with the high turbulences normally occurring in the dyeing process, foaming can be impaired the quality of the dyeing by the formation of unlevelnesses. Examples of wetting agents used are ethoxylation and/or propoxylation products of fatty alcohols or propylene oxide/ethylene oxide block copolymers, ethoxylated or propoxylated fatty alcohols or oxo alcohols, and also ethoxylates of oleic acid or alkylphenols, alkylphenolethersulfates, alkylpolyglycosides, alkylphosphonates, alkylphenylphosphonates, alkylphosphates or alkylphenylphosphates.

Dry woven or knitted textile fabrics, such as those used in continuous pigment dyeing, comprise a large amount of air. If it is desired to dye dry woven textile fabrics, it is advantageous to use deaerators in the dyeing process according to the invention. These are based e.g. on polyethersiloxane copolymers or phosphoric acid esters. They can be present in the dyeing liquors according to the invention in amounts of 0.01 to 2 g/l.

Other auxiliaries which can be added to the dyeing liquors according to the invention are one or more handle improvers. These are normally polysiloxanes or waxes based on polyethylene or polyethylene glycol. Polysiloxanes have the advantage of permanence, whereas some waxes can be washed out slowly during use. However, in one embodiment of the present invention, it is possible to dispense with the addition of handle improvers.

Other auxiliaries which can be added to the dyeing liquors according to the invention are one or more migration inhibitors. Examples of suitable migration inhibitors are co-polymers of acrylic acid with acrylamide. The molar proportion of acrylic acid can be between 20 and 80%, the proportion of acrylamide making up the difference to 100. Examples of other suitable migration inhibitors are random copolymers or block co-polymers of ethylene oxide with propylene oxide. The molar proportion of ethylene oxide can be between 20 and 80%, the proportion of propylene oxide making up the difference to 100.

In one embodiment of the present invention, dyeing liquors according to the invention have a weakly acidic pH, preferably ranging from 4 to 6.5.

In one embodiment of the present invention, the dynamic viscosity of the dyeing liquors according to the invention is in the range below 100 mPa·s, measured at 20° C. The surface tensions of the dyeing liquors according to the invention are to be adjusted so that the goods can be wetted. The surface tensions are commonly below 50 mN/m, measured at 20° C.

Another feature of the present invention is a process for the preparation of the dyeing liquors according to the invention. The preparative process according to the invention conventionally comprises mixing at least one pigment in particulate form, treated according to the invention, with one or more of the additives listed above, such as sol-vents, defoamers, handle improvers, emulsifiers and/or biocides, and making up the volume with water. The process conventionally comprises stirring the components in a mixing vessel, the size and shape of which are not critical. The stirring is preferably followed by clarification.

Another feature of the present invention is a process for the dyeing of textile substrates using the dyeing liquors according to the invention described above. The process can be carried out in the commonly employed machines, preference being given to padding machines, which comprise, as the essential element, two rolls pressing on one another, through which the textile is fed. The liquid is introduced above the rolls and wets the textile. The pressure squeezes the textile off and ensures a constant application.

In another embodiment, the textile is fed over a deflection roller through a trough containing the dyeing liquor. Excess liquor is then squeezed off through a pair of rolls mounted above the liquor, thus ensuring a constant application.

The actual dyeing step is conventionally followed by thermal drying and fixing, the drying preferably being carried out at temperatures of 70 to 120° C. over a period of 30 seconds to 3 minutes and the subsequent fixing being carried out at temperatures of 150° C. to 200° C. over a period of 30 seconds to 5 minutes.

A preferred pigment dyeing process is the padding process. Substrates colored according to the invention, especially printed and/or dyed substrates, are distinguished by a particular brightness of the colors coupled with an outstanding handle of the printed or dyed substrates. Another feature of the present invention therefore consists of substrates colored by the process described above using the dyeing liquors according to the invention.

If it is desired to prepare printing pastes according to the invention, it is possible according to the invention to incorporate at least one treated pigment (A) in particulate form into a printing paste. Advantageously, the printing paste according to the invention for pigment printing is prepared from at least one treated pigment (A) in particulate form by mixing with auxiliaries commonly used in the printing process, and then adjusting the colorant content by dilution with water.

Common auxiliaries are known from Ullmann, Handbuch der technischen Chemie und Verfahrenstechnik (Handbook of Industrial Chemistry and Chemical Engineering); cf., for example, Ullmann's Encyclopedia of Industrial Chemistry, 5th edition, key words: Textile Auxiliaries, vol. A26, p. 286 et seq. and 296 et seq., Verlag Chemie, Weinheim, Deerfield/Florida, Basel; 1996. Common auxiliaries which may be mentioned are e.g. thickeners, fixing agents, handle improvers and emulsifiers.

The thickeners used can be natural or synthetic. It is preferable to use synthetic thickeners, e.g. generally liquid solutions of synthetic polymers in e.g. white oil, or aqueous solutions. The polymers comprise acid groups, of which all or a certain percentage have been neutralized with ammonia. The fixing process releases ammonia, which lowers the pH and starts the actual fixing process. The pH lowering required for fixing can alternatively be brought about by the addition of non-volatile acids such as citric acid, succinic acid, glutaric acid or malic acid.

The finished paste according to the invention can comprise 30 to 70% by weight of white oil. Aqueous thickeners conventionally comprise up to 25% by weight of polymer. If it is desired to use aqueous thickener formulations, aqueous ammonia is generally added. It is also conceivable to use granular, solid thickener formulations in order to be able to prepare pigment pastes without creating emissions.

Printing pastes according to the invention can also comprise handle improvers, which are conventionally selected from silicones, especially polydimethylsiloxanes, and fatty acid esters. Examples of commercially available handle improvers which can be added to the printing pastes according to the invention are Acramino Weichmacher Si (Bayer AG), Luprimol SIG® and Luprimol CW® (BASF Aktiengesellschaft).

Other additives which can be incorporated into printing pastes according to the invention are one or more emulsifiers, especially when the pastes comprise thickeners containing white oil and are obtained as an oil-in-water emulsion. Examples of suitable emulsifiers are aryl- or alkyl-substituted polyglycol ethers. Commercially available ex-amples of suitable emulsifiers are Emulgator W® (Bayer), Luprintol PE New® and Lu-printol MP® (BASF Aktiengesellschaft).

Other possible additives are Brønsted acids, which are preferably used particularly in the case of non-water-based pastes. Ammonium salts of inorganic acids, e.g. diammonium hydrogen phosphate, are preferred.

Pigment printing using at least one pigment in particulate form, treated according to the invention, can be carried out by different processes known per se. The normal process uses a template through which the printing paste is pressed with a squeegee. This is one of the screen printing processes. The substrate is then exposed to thermal energy or at least one catalyst is added. The pigment printing process according to the invention using the printing pastes according to the invention produces printed substrates with a particularly high brightness and depth of shade of the prints, coupled with an excellent handle of the printed substrates. The present invention therefore provides substrates printed by the process according to the invention using the printing pastes according to the invention.

Another embodiment of the present invention consists of substrates, especially textile substrates, which have been colored by one of the above-mentioned processes according to the invention and are distinguished by particularly sharply printed images or drawings and by an excellent handle.

### General Preliminary Remarks

n-C₁₈H₃₇—(OCH₂CH₂)₂₅—OH is n-octadecanol ethoxylated with ethylene oxide, prepared according to the following instructions:

242 g of n-octadecanol and 0.1 mol of KOH flakes were dehydrated in an autoclave at a temperature of 100° C. and a pressure of 1 mbar over a period of 2 hours, the vacuum was then let down with nitrogen and the autoclave was flushed 3 times with nitrogen and then heated to 130° C. After the temperature had been reached, 1100 g of ethylene oxide were metered in continuously over 3 h 20 min at a pressure of up to 6.1 bar. When the addition was complete, the reaction was allowed to proceed until the pressure became constant. The autoclave was then cooled to 100° C. and degassed at 1 mbar for 60 min and the reaction product was discharged at 70° C. The yield was 1337 g.

The glass transition temperature was determined with a DSC822 apparatus (series TA8200) from Mettler-Toledo using a TSO 801 RO autosampler. The DSC apparatus was equipped with an FSR5 temperature sensor. The procedure was conducted according to DIN 53765.

### I. Preparation of Treated Pigments

I. 1a) Dispersion of a pigment with a non-ionic surfactant
I. 1a) Blue pigment

The following were ground together in a Drais Superflow DCP SF 12 stirred ball mill:

| | |
|---|---|
| 1800 g | Pigment Blue 15:3 |
| 450 g | n-C₁₈H₃₇O(CH₂CH₂O)₂₅H |
| 24 g | glutaric dialdehyde |
| 30 g | tetramethylolacetylenediurea |
| 3696 g | distilled water |

Grinding was continued until the pigment particles had a mean diameter of 130 nm. This gave dispersion I. 1a) of pigment particles and non-ionic surfactant.

I. 2a) Dispersion of a Black Pigment with a Non-Ionic Surfactant

The following were ground together in a Drais Superflow DCP SF 12 stirred ball mill:

| | |
|---|---|
| 1800 g | Pigment Black 7 |
| 450 g | n-C₁₈H₃₇O(CH₂CH₂O)₂₅H |
| 3696 g | distilled water |

Grinding was continued until the pigment particles had a mean (number-average) diameter of 150 nm. This gave dispersion I. 2a) of pigment particles and non-ionic surfactant.

I. 3a) Dispersion of a Red Pigment with a Non-Ionic Surfactant

| | |
|---|---|
| 1800 g | Pigment Red 146 |
| 450 g | n-C₁₈H₃₇O(CH₂CH₂O)₂₅H |
| 24 g | glutaric dialdehyde |
| 30 g | tetramethylolacetylenediurea |
| 3696 g | distilled water |

Grinding was continued until the pigment particles had a mean diameter of 130 nm. This gave dispersion I. 3a) of pigment particles and non-ionic surfactant.

I. 4a) Dispersion of a Yellow Pigment with a Non-Ionic Surfactant

| | |
|---|---|
| 1800 g | Pigment Yellow 138 |
| 450 g | n-C₁₈H₃₇O(CH₂CH₂O)₂₅H |
| 24 g | glutaric dialdehyde |
| 30 g | tetramethylolacetylenediurea |
| 3696 g | distilled water |

Grinding was continued until the pigment particles had a mean diameter of 130 nm. This gave dispersion I. 4a) of pigment particles and non-ionic surfactant.

I. b) Mixing with Water
I. 1b) Mixing of 1.1a) with Water

39.3 g of the dispersion of 1.1a) were dispersed with 59.2 g of fully demineralized water, with stirring, in a 1 l tank fitted with a stirrer, a nitrogen attachment and three metering devices. 2.1 g of C₁₂H₂₅(OC₂H₄)ₐOSO₃Na (28% by weight, a=2.5), as an aqueous solution, and 8.85 g of styrene were added and the pH was adjusted to 6.2 with formic acid.

This gave mixture I. 1b) of pigment in particulate form with aqueous medium.

I. 2b) Mixing of I. 2a) with Water

39.3 g of the dispersion of I. 2a) were dispersed with 59.2 g of fully demineralized water, with stirring, in a 1 l tank fitted with a stirrer, a nitrogen attachment and three metering devices. 2.1 g of C₁₂H₂₅(OC₂H₄)ₐOSO₃Na (28% by weight, a=2.5), as an aqueous solution, and 8.85 g of styrene were added and the pH was adjusted to 6.2 with formic acid.

This gave mixture I. 2b) of pigment in particulate form with aqueous medium.

I. 3b) Mixing of I. 3a) with Water

640 g of the dispersion of I. 3a) were dispersed with 650 g of fully demineralized water, with stirring, in a 1 l tank fitted with a stirrer, a nitrogen attachment and three metering devices. 17.1 g of 28% by weight sodium laurylsulfate, as an aqueous solution, and 48 g of styrene were added.

This gave mixture I. 3b) of pigment in particulate form with aqueous medium.

I. 4b) Mixing of I. 4a) with Water

640 g of the dispersion of I. 4a) were dispersed with 650 g of fully demineralized water, with stirring, in a 1 l tank fitted with a stirrer, a nitrogen attachment and three metering devices. 17.1 g of 28% by weight sodium laurylsulfate, as an aqueous solution, and 48 g of styrene were added.

This gave mixture I. 4b) of pigment in particulate form with aqueous medium.

### I. c) Polymerization

### I. 1c) Polymerization of I. 1b)

Nitrogen was passed through the mixture of step I. 1b) over a period of 1 hour. The dispersion was then heated to 85° C., after which 0.3 g of tert-butyl hydroperoxide (10% by weight in water) and 0.3 g of HOCH₂SO₂Na were added.

The formation of a water-insoluble polymer on the pigment in particulate form is observed.

### I. 2c) Polymerization of I. 2b)

Nitrogen was passed through the mixture of step I. 1b) over a period of 1 hour. The dispersion was then heated to 85° C., after which 0.3 g of tert-butyl hydroperoxide (10% by weight in water) and 0.3 g of HOCH₂SO₂Na were added.

The formation of a water-insoluble polymer on the pigment in particulate form is observed.

### I. 3c) Polymerization of I. 3b)

Nitrogen was passed through the mixture of step I. 3b) over a period of 1 hour. The dispersion was then heated to 85° C., after which 0.7 g of tert-butyl hydroperoxide (70% by weight in water) and 0.48 g of HOCH₂SO₂Na were added.

The formation of a water-insoluble polymer on the pigment in particulate form is observed.

### I. 4c) Polymerization of I. 4b)

Nitrogen was passed through the mixture of step I. 4b) over a period of 1 hour. The dispersion was then heated to 85° C., after which 0.7 g of tert-butyl hydroperoxide (70% by weight in water) and 0.48 g of HOCH₂SO₂Na were added. The formation of a water-insoluble polymer on the pigment in particulate form is observed.

### I. d) Addition of an Emulsion of Comonomers, and Further Copolymerization

### I. 1d) Addition of an Emulsion of Comonomers, and Further Copolymerization to I. 1c)

15 minutes after the addition of tert-butyl hydroperoxide and HOCH₂SO₂Na according to step I. 1c), a mixture of the following composition was added over a period of 60 minutes:

100 g of fully demineralized water
13.4 g of 28% by weight aqueous solution of C₁₂H₂₅(OCH₂CH₂)ₐOSO₃Na where a=3 6.6 g of 56.5% by weight aqueous solution of sodium salt of sulfosuccinic acid di-2-ethylhexyl ester
2.5 g of acrylic acid
7.5 g of 15% by weight aqueous solution of N-methylolmethacrylamide
150 g of n-butyl acrylate
90 g of styrene

The addition of a solution of 1.25 g of Na₂S₂O₈ in 60 g of water was started at the same time and was continued over a period of 105 minutes. The temperature was kept at 85° C. during the addition.

When the addition had ended, stirring was continued for 30 minutes at 85° C. and the mixture was then deodorized by the simultaneous introduction of a solution of 1.1 g of tert-butyl hydroperoxide (70% in water) in 15 g of fully demineralized water and a solution of 0.7 g of HOCH₂SO₂Na in 15 g of fully demineralized water over a period of 90 minutes.

The mixture was then cooled to room temperature and the pH was adjusted to 7 with 25% by weight aqueous ammonia. The resulting dispersion was subsequently filtered through a 120 μm mesh and then through a 15 μm mesh. The solids content of dispersion D.1.1 was 37.8% by weight. The particle diameter distribution was determined with an Autosizer IIC apparatus from Malvern according to ISO 13321 and gave a maximum at 137 nm.

This gave an aqueous dispersion D.1.1 of treated pigment in particulate form.

Data for the preparation of other dispersions are collated in Table 1.

### I. 15d) Addition of an Emulsion of Comonomers, and Further Copolymerization to I. 2c)

15 minutes after the addition of tert-butyl hydroperoxide and HOCH₂SO₂Na according to step I. 2c), a mixture of the following composition was added over a period of 60 minutes:

42.4 g of fully demineralized water

16 g of C₁₂H₂₅(OC₂H₄)ₐOSO₃Na (28% by weight, a=2.5)

0.8 g of acrylic acid
10 g of N-methylolmethacrylamide (15% in water)
30 g of n-butyl acrylate
17.75 g of styrene

The addition of 11.25 g of tert-butyl hydroperoxide (10% in water) and 10.1 g of HOCH₂SO₂Na (10% by weight in water) in a further 1.1 g of fully demineralized water was started at the same time and was continued over a period of 120 minutes. The temperature was kept at 85° C. during the addition.

When the addition had ended, stirring was continued for 30 minutes at 85° C. The addition of 11.25 g of tert-butyl hydroperoxide (10% in water) and 10.1 g of HOCH₂SO₂Na (10% by weight in water) in 1.1 g of fully demineralized water was then started and was continued over a period of 90 minutes. The temperature was kept at 85° C. during the addition. The mixture was subsequently cooled to room temperature and the resulting dispersion was then filtered through a 125 μm mesh.

This gave aqueous dispersion D.2.1 of treated pigment in particulate form.

The solids content of D.2.1 was 29.6%. The particle diameter distribution was deter-mined with an Autosizer IIC apparatus from Malvern according to ISO 13321 and gave maxima at 127 and 444 nm.

### I. 17d) Addition of an Emulsion of Comonomers, and Further Copolymerization to I. 3c)

10 minutes after the addition of tert-butyl hydroperoxide and HOCH₂SO₂Na according to step I. 3c), a mixture of the following composition was added over a period of 120 minutes:

500 g of fully demineralized water
80 g of 30% by weight aqueous solution of C₁₂H₂₅(OCH₂CH₂)ₐOSO₃Na where a=3 53.3 g of 45% by weight aqueous solution of sodium salt of sulfosuccinic acid di-2-ethylhexyl ester
16 g of acrylic acid
68.6 g of 35% by weight aqueous solution of N-methylolacrylamide
400 g of n-butyl acrylate
80 g of styrene
280 g of ethyl acrylate

The addition of 26.3 g of tert-butyl hydroperoxide (70% by weight in water) in a further 150 g of fully demineralized water and 16 g of HOCH₂SO₂Na in 160 g of fully demineralized water was started at the same time and was continued over a period of 180 minutes. The temperature was kept at 85° C. during the addition.

When the addition had ended, stirring was continued for 30 minutes at 85° C.

The mixture was then cooled to room temperature and the pH was adjusted to 7.5 with 25% by weight aqueous ammonia. The resulting dispersion was then filtered through a 150 μm mesh to give aqueous dispersion D.3.1. The solids content of D.3.1 was 35.7% by weight. The particle diameter distribution was determined with an Autosizer IIC apparatus from Malvern according to ISO 13321 and gave a maximum at 130 nm.

### I. 18d) Addition of an Emulsion of Comonomers, and Further Copolymerization to I. 4c)

10 minutes after the addition of tert-butyl hydroperoxide and HOCH₂SO₂Na according to step I. 4c), a mixture of the following composition was added over a period of 120 minutes:

500 g of fully demineralized water
80 g of 30% by weight aqueous solution of C₁₂H₂₅(OCH₂CH₂)ₐOSO₃Na where a=3 53.3 g of 45% by weight aqueous solution of sodium salt of sulfosuccinic acid di-2-ethylhexyl ester
16 g of acrylic acid
68.6 g of 35% by weight aqueous solution of N-methylolacrylamide
400 g of n-butyl acrylate
80 g of styrene
280 g of ethyl acrylate

The addition of 26.3 g of tert-butyl hydroperoxide (70% by weight in water) in a further 150 g of fully demineralized water and 16 g of HOCH₂SO₂Na in 160 g of fully demineralized water was started at the same time and was continued over a period of 180 minutes. The temperature was kept at 85° C. during the addition.

When the addition had ended, stirring was continued for 30 minutes at 85° C.

The mixture was then cooled to room temperature and the pH was adjusted to 7.5 with 25% by weight aqueous ammonia. The resulting dispersion was then filtered through a 150 μm mesh to give aqueous dispersion D.4.1. The solids content of D.4.1 was 36.3% by weight. The particle diameter distribution was determined with an Autosizer IIC apparatus from Malvern according to ISO 13321 and gave a maximum at 109.

TABLE 1
Dispersions of treated pigments (Disp.) and comonomer mixtures of steps I.1d) to I.18d);
unless expressly indicated otherwise above, numerical values are in % by weight, based
on the total amount of comonomers used in step d) (sum: 243.6 g in each case)

| No. | Disp. | BA | EHA | EA | MMA | S | AN | MAMOL | AMOL | GMA |
|---|---|---|---|---|---|---|---|---|---|---|
| I.1d) | D.1.1 | 61.6 | | | | 36.9 | | 0.5 | | |
| I.2d) | D.1.2 | 65.5 | | | | 30 | | 3 | | |
| I.3d) | D.1.3 | 63.5 | | | | 31 | | | | |
| I.4d) | D.1.4 | 29 | 20 | | 8 | 36.3 | | 4.5 | | |
| I.5d) | D.1.5 | 37 | | | | 48.8 | 8.7 | 3 | | |
| I.6d) | D.1.6 | 35 | | | 51.8 | | 7 | 3.2 | | |
| I.7d) | D.1.7 | 14.5 | | 25 | 48.3 | | | | | 5 |
| I.8d) | D.1.8 | 20.8 | | 20 | 53 | | | 2.5 | | |
| I.9d) | D.1.9 | | 5 | 32.8 | 50 | | | | | 5 |
| I.10d) | D.1.10 | 5 | | 30.8 | 58 | | | 2.5 | | |
| I.11d) | D.1.11 | 10 | | 20 | 56.8 | | 7 | 3.2 | | |
| I.12d) | D.1.12 | 50 | | 35 | | 10 | | | 3 | |
| I.13d) | D.1.13 | 43 | | 35 | | 8.5 | | | | |
| I.14d) | D.1.14 | 48.5 | | 35 | | 10 | | | | |
| I.15d) | D.2.1 | 59.9 | | | | 35.5 | | 3 | | |
| I.16d) | D.2.2 | 48.5 | | 35 | | 10 | | | | |
| I.17d) | D.3.1 | 50 | | 35 | | 10 | | | 3 | |
| I.18d) | D.4.1 | 50 | | 35 | | 10 | | | 3 | |

| | BMA- | | | | | | | T_{g} | |
|---|---|---|---|---|---|---|---|---|---|
| No. | acac | HPA | HEA | AM | MAM | AA | MAA | [° C.] | Color |
| I.1d) | | | | | | 1.0 | | −3 | blue |
| I.2d) | | | | | | 1.5 | | −8 | blue |
| I.3d) | 5 | | | | | 0.5 | | −14 | blue |
| I.4d) | | | | | | 2.2 | | 12 | blue |
| I.5d) | | | | 0.5 | | | 2 | 32 | blue |
| I.6d) | | | | 1 | | 2 | | 36 | blue |
| I.7d) | | 4.7 | | | 2.5 | | | 35 | blue |
| I.8d) | | | | | 2.5 | 1.2 | | 38 | blue |
| I.9d) | | 4.7 | | | 2.5 | | | 42 | blue |
| I.10d) | | | | | 2.5 | 1.2 | | 53 | blue |
| I.11d) | | | | 1 | | 2 | | 57 | blue |
| I.12d) | | | | | | 2 | | −22 | blue |
| I.13d) | | | 10 | 1.5 | | 2 | | −14 | blue |
| I.14d) | | | 3 | 1.5 | | 2 | | −17 | blue |
| I.15d) | | | | | | 1.6 | | +1 | black |
| I.16d) | | | 3 | 1.5 | | 2 | | −17 | black |
| I.17d) | | | | | | 2 | | −20 | red |
| I.18d) | | | | | | 2 | | −20 | yellow |

Abbreviations used: BA: n-butyl acrylate, EHA: 2-ethylhexyl acrylate, EA: ethyl acrylate, MMA: methyl methacrylate, S: styrene, AN: acrylonitrile, MAMOL: N-methylolmethacrylamide, AMOL: N-methylolacrylamide, GMA: glycidyl methacrylate, BMA-acac: 1,4-butanediol monoacrylate acetylacetate, HPA: 3-hydroxypropyl acrylate, HEA: 2-hydroxyethyl acrylate, AM: acrylamide, MAM: methacrylamide, AA: acrylic acid, MAA: methacrylic acid.

### II. Preparation of Dyeing Liquors According to the Invention, and Dyeing According to the Invention

Working instructions for the preparation and processing of dyeing liquors according to the invention (padding process, Examples 11.1 to 11.7):

A dyeing liquor was prepared by stirring the substances shown in Table 2 into 90% by weight of the indicated amount of water, and the solids content was then adjusted to the desired value with the remaining water. All the amounts are indicated in g/kg of padding liquor.

The resulting dyeing liquor was used to impregnate gray cotton cloth on a padding ma-chine (manufactured by Mat this, no. HVF12085). The liquor uptake was 70% at a speed of 2 m/min. Immediately after padding, the cloth was dried on a dryer (Mat this DHE-36582 dryer-steamer) for 50 sec. at 110° C. It was then fixed on a fixer (Mat this LTF89584 dryer-fixer) for 45 s at 180° C.

The rubbing fastness was determined analogously to ISO 105-X12. Evaluation was made on the gray scale (ISO 105-A02).

TABLE 2
Dyeing liquors according to the invention
and results of the dyeing experiments

| | II.1 | II.2 | II.3 | II.4 | II.5 | II.6 | II.7 |
|---|---|---|---|---|---|---|---|
| D.1.12 [g/l] | 200 | 10 | | | 30 | 200 | |
| D.4.1 [g/l] | | 50 | | 75 | 150 | | |
| D.3.1 [g/l] | | 40 | 75 | | 120 | | |
| D.2.2 [g/l] | | | | | | | 230 |
| VII.1 (B1.1) [g/l] | 5 | 5 | 5 | 5 | | | |
| VIII.1 (B2.1) [g/l] | | | | | 8 | 8 | 7.5 |
| Auxiliary 1 [g/l] | 20 | 10 | 10 | 10 | 30 | 30 | 30 |
| Auxiliary 2 [g/l] | 15 | 15 | 15 | 15 | 15 | 15 | 15 |
| (NH₄)₂HPO₄ [g/l] | 5 | 10 | 10 | 10 | 5 | 5 | |
| Na₂SO₄ [g/l] | 10 | 10 | 10 | 10 | 10 | 10 | 10 |
| Water [g/l] | 745 | 845 | 875 | 875 | 632 | 732 | 707.5 |
| Rubbing-brushing | 4-5 | 4-5 | 4-5 | 5 | 4-5 | 4-5 | 4 |
| wash [score] | | | | | | | |

### Abbreviations:

Auxiliary 1: block copolymer (EO)₂₉(PO)₄₂, EO: ethylene oxide, PO: propylene oxide
Auxiliary 2: n-C₁₈H₃₇O(CH₂CH₂O)₂₅H

### VII.1 (B1.1): 80% by Weight Solution of

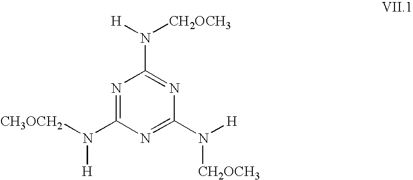

in water/ethylene glycol (proportions by weight: 4:1)

VIII.2 (B2.1): 70% by Weight Solution of a Reaction Product of

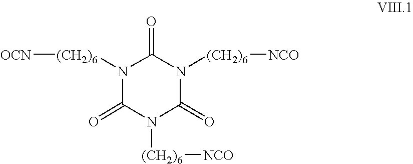

with Propylene Glycol In Propylene Glycol

### III. Preparation of Pigment Printing Pastes According to the Invention, and Printing Experiments

General working instructions for the preparation of pigment printing paste according to the invention and comparative pigment printing paste, and printing experiments (Examples V-III.1 and III.2): Using a high-speed stirrer, 48 g of a synthetic thickener (polyacrylic acid of M_{w} 200,000 g, quantitatively neutralized with ammonia) were stirred into 90% by weight of the required amount of water shown in Table 3. The thickener was allowed to swell and 5 g/kg of auxiliary 2 (n-C₁₈H₃₇O(CH₂CH₂O)₂₅H), aqueous dispersion D.1.14 and, if appropriate, compound VIII.1 were then added, with vigorous stirring. This gave pigment printing paste III.2 according to the invention or comparative pigment printing paste V-III.1. After homogenization, pigment printing paste III.2 or comparative pigment printing paste V-III.1 was printed onto cotton through a screen printing template (120 mesh) by means of a circular squeegee (diameter 8 mm, tension 7). The resulting print was subsequently dried at 110° C. for 60 s and then fixed for 5 min at 150° C.

TABLE 3
Pigment printing pastes, their composition and properties,
and results of the printing experiments

| Example | V-III.1 | III.2 |
|---|---|---|
| D.1.14 [g/kg] | 160 | 160 |
| Auxiliary 2 [g/kg] | 5 | 5 |
| Synthetic thickener [g/kg] | 48 | 48 |
| VIII.1 (B2.1) [g/kg] | 0 | 4 |
| Water [g/kg] | 787 | 783 |
| Viscosity (dpa · s) | 70 | 70 |
| Rubbing fastness, dry [score] | 2-3 | 4 |
| Rubbing fastness, wet [score] | 1 | 2-3 |
| Rubbing-brushing wash [score] | 1 | 3 |

Amounts are indicated in g/kg, based in each case on pigment printing paste.

General working instructions for determining the fastness in the rubbing-brushing wash:

An aqueous washing solution comprising 5 g/l of Verna needle soap according to ISO 105-C03 and 3 g/l of anhydrous sodium carbonate was prepared. A dyed or printed textile (“test sample”, length 25 cm, width 4 cm) was treated for 30 minutes at the boil in said washing solution. The test sample was removed from the washing solution and clamped at the ends on a firm surface and 100 ml of the hot washing solution were poured over it. It is then rubbed 30 times to- and -fro with a brush over a length of 10 cm. The test sample was removed and rinsed twice with cold (15° C.) fully demineralized water and then under cold (15° C.) running tap water (10° dH). The test sample treated in this way was spun and ironed dry. After the test sample had cooled, the color change was evaluated on the gray scale (ISO 105-A02).

1. A process for the printing or coloring of substrates, wherein substrates to be printed or colored are brought into contact with
(A) at least one treated pigment in particulate form which is prepared by a process comprising the following steps:
a) of dispersing at least one pigment in particulate form with at least one non-ionic surfactant,
b) mixing the resulting dispersion with an aqueous medium,
c) polymerizing at least one first monomer or copolymerizing a first mixture of comonomers in the presence of a mixture according to step b), whereby a water-insoluble polymer or copolymer is formed on the surface of the pigment in particulate form, and
d) polymerizing or copolymerizing at least one second monomer or a second mixture of comonomers on the surface of the product of step c), and also with
(B) at least one compound which is capable of crosslinking under the action of thermal energy or after the addition of a catalyst.

2. The process according to claim 1 wherein the polymer or copolymer prepared in step d) has a glass transition temperature T_{g} of about −25° C. or above.

3. The process according to claim 1 wherein (B) is selected from
(B1) melamine derivatives, which can optionally be alkoxylated, alkoxyalkylated or converted to half-aminals,
(B2) hydrophilized isocyanurates,
(B3) polyglycidyl ethers having 2 to 5 glycidyl groups per molecule,
(B4) carbodiimides, and
(B5) urea or urea derivatives, which can optionally be converted to half-aminals or aminals.

4. The process according to claim 1 wherein the pigments in particulate form are organic pigments.

5. The process according to one claim 1 wherein the first monomer in step c) is a vinylaromatic compound or a compound of general formula I: 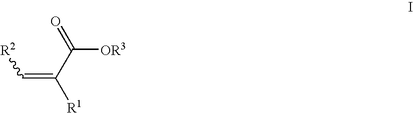
in which the variables are defined as follows:
R¹ is selected from hydrogen and unbranched or branched C₁-C₁₀-alkyl,
R² is selected from hydrogen and unbranched or branched C₁-C₁₀-alkyl,
R³ is selected from unbranched or branched C₄-C₁₀-alkyl.

6. The process according to claim 1 wherein the first mixture of comonomers is a mixture of at least one vinylaromatic compound and at least one compound of general formula I: 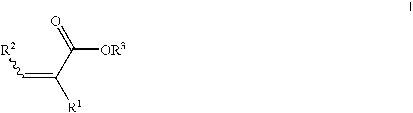
in which the variables are defined as follows:
R¹ is selected from hydrogen and unbranched or branched C₁-C₁₀-alkyl,
R² is selected from hydrogen and unbranched or branched C₁-C₁₀-alkyl,
R³ is selected from unbranched or branched C₄-C₁₀-alkyl.

7. The process according to claim 5 wherein R¹ and R² in the compound of general formula I are hydrogen.

8. The process according to claim 1 wherein the second monomer added is a monomer of general formula II: 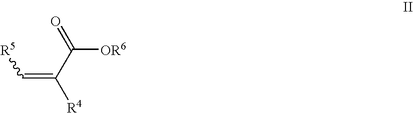
in which the variables are defined as follows:
R⁴ is selected from hydrogen and unbranched or branched C₁-C₁₀-alkyl,
R⁵ is selected from hydrogen and unbranched or branched C₁-C₁₀-alkyl,
R⁶ is selected from unbranched or branched C₁-C₁₀-alkyl.

9. The process according to claim 1 wherein the second mixture of comonomers comprises at least one monomer of general formula II: 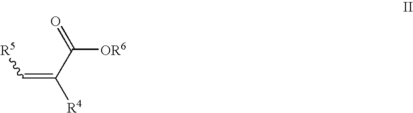
in which the variables are defined as follows:
R⁴ is selected from hydrogen and unbranched or branched C₁-C₁₀alkyl,
R⁵ is selected from hydrogen and unbranched or branched C₁-C₁₀-alkyl,
R⁶ is selected from unbranched or branched C₁-C₁₀-alkyl.

10. The process according to claim 8 wherein R⁴ in the compound of general formula II is hydrogen or methyl and R⁵ is hydrogen.

11. The process according to claim 9 to wherein the second mixture of comonomers comprises at least one comonomer selected from a vinylaromatic compound and a compound of general formula I: 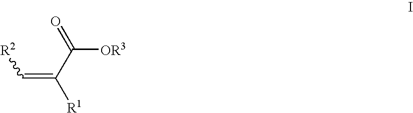
in which the variables are defined as follows:
R¹ is selected from hydrogen and unbranched or branched C₁-C₁₀-alkyl,
R² is selected from hydrogen and unbranched or branched C₁-C₁₀-alkyl,
R³ is selected from unbranched or branched C₄-C₁₀-alkyl.

12. The process according to claim 1 wherein, in step d), up to 20% by weight, based on the second mixture of comonomers, of at least one compound of formula V a or V b: 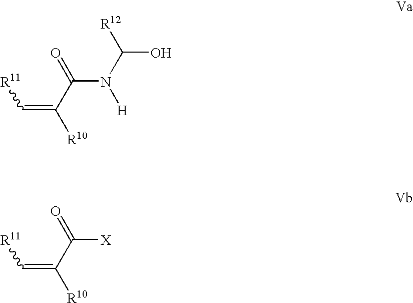
is present, in which the variables are defined as follows:
R¹⁰ to R¹² are identical or different and selected from hydrogen and unbranched or branched C₁-C₁₀-alkyl, and
X is selected from hydrogen, glycidyl, protonatable groups carrying tertiary amino groups, and enolizable groups having 1 to 20 C atoms.

13. The process according to claim 1 which is an ink-jet process.

14. An ink for the ink-jet process, comprising
(A) at least one treated pigment in particulate form which is prepared by a process comprising the following steps:
a) dispersing at least one pigment in particulate form with at least one non-ionic surfactant,
b) mixing the resulting dispersion with an aqueous medium,
c) polymerizing at least one first monomer or of copolymerizing a first mixture of comonomers in the presence of a mixture according to step b), whereby a water-insoluble polymer or copolymer is formed on the surface of the pigment in particulate form, and
d) polymerizing or copolymerizing at least one second monomer or a second mixture of comonomers on the surface of the product of step c), and also
(B) at least one compound which is capable of crosslinking under the action of thermal energy or after the addition of a catalyst.

15. A process for printing substrates by the ink-jet process using an ink according to claim 14.

16. The process according to claim 15 wherein the substrates are textile substrates.

17. A printed substrate obtainable by the process according to claim 15.

18. A dyeing liquor for textile dyeing, comprising
(A) at least one treated pigment in particulate form which is prepared by a process comprising the following steps:
a) dispersing at least one pigment in particulate form with at least one non-ionic surfactant,
b) mixing the resulting dispersion with an aqueous medium,
c) polymerizing at least one first monomer or of copolymerizing a first mixture of comonomers in the presence of a mixture according to step b), whereby a water-insoluble polymer or copolymer is formed on the surface of the pigment in particulate form, and
d) polymerizing or copolymerizing at least one second monomer or a second mixture of comonomers on the surface of the product of step c), and also
(B) at least one compound which is capable of crosslinking under the action of thermal energy or after the addition of a catalyst.

19. A printing paste for pigment printing, comprising
(A) at least one treated pigment in particulate form which is prepared by a process comprising the following steps:
a) dispersing at least one pigment in particulate form with at least one non-ionic surfactant,
b) mixing the resulting dispersion with an aqueous medium,
c) polymerizing at least one first monomer or copolymerizing a first mixture of comonomers in the presence of a mixture according to step b), whereby a water-insoluble polymer or copolymer is formed on the surface of the pigment in particulate form, and
d) polymerizing or copolymerizing at least one second monomer or a second mixture of comonomers on the surface of the product of step c), and also
(B) at least one compound which is capable of crosslinking under the action of thermal energy or after the addition of a catalyst.

20. A colored textile substrate obtainable by a process according to claim 1.
